(19) United States
(12) Patent Application Publication
(10) Pub. No.: US 2014/0379857 A1
(43) Pub. Date: Dec. 25, 2014

(54) METHOD AND APPARATUS FOR PROVIDING CONTENT WITH STREAMING

(71) Applicant: SAMSUNG ELECTRONICS CO., LTD., Suwon-si (KR)

(72) Inventor: Hyo-won KIM, Suwon (KR)

(73) Assignee: SAMSUNG ELECTRONICS CO., LTD., Suwon-si (KR)

(21) Appl. No.: 14/282,238

(22) Filed: May 20, 2014

(30) Foreign Application Priority Data
Jun. 24, 2013 (KR) 10-2013-0072598

(51) Int. Cl. H04L 29/08

(52) U.S. Cl. CPC H04L 67/32
USPC 709/217

(57) ABSTRACT

A method for providing content with streaming comprises storing a plurality of pieces of content; receiving a content retrieval request from a user; checking a network environment of the user; retrieving content according to the content retrieval request; and providing content information in which the retrieved content matches the checked network environment.

### CROSS-REFERENCE TO RELATED APPLICATIONS

This application claims priority to Korean Patent Application No. 10-2013-0072598, filed on Jun. 24, 2013 in the Korean Intellectual Property Office, the disclosure of which is incorporated herein by reference.

### BACKGROUND

1. Field

Apparatuses and methods consistent with the exemplary embodiments relate to a method and an apparatus for providing content with streaming, and more particularly, to a method and an apparatus for providing content with streaming, capable of selecting or providing content of a quality suitable for a streaming service which reflects a network environment of a user.

2. Description of the Related Art

In the related art, shown in FIG. 8, when a user wants to retrieve specific content, the user accesses a content portal 30 through a user terminal 10 to request retrieval of the specific content using a keyword. The content portal 30 performs retrieval from a database 20 to store information about content provided by content providers 40-1, 40-2 and 40-3 on the basis of the keyword input by the user.

If content information corresponding to the keyword input by the user is retrieved, the content portal 30 provides the retrieved content information to the user, so that the user can move to a web page provided by the content providers 40-1, 40-2 and 40-3. For example, if the user requests retrieval of a movie using a movie title as a keyword, the content portal 30 retrieves applications of content providers which provide the content, and provides a retrieval result to the user. Then, if the user executes a desired application to access the retrieved content, the web page goes to a page for reproduction or purchase of the movie.

Specifically, if the user requests retrieval of a movie “Avatar”, the content portal 30 retrieves various content providers such as Vudu, Blockbuster and Netflix which provide “Avatar”, and provides the result to the user. Then, if the user selects Netflix, the web page goes to a page for “Avatar” of Netflix. Thus, the user may view the movie with streaming.

However, in such a video content portal in the related art, retrieval and arrangement of video content is simply performed by only a keyword of a movie title. Further, in a case where various content providers provide the same movie with different qualities, a user cannot confirm the fact before reproduction.

Consequently, for example, although the user has a network environment which allows viewing of high quality video content with streaming, the user may view low quality video content. Further, for example, although the user has an inadequate network environment, the user may select high quality video content, so that the user may not be provided with a smooth streaming service.

### SUMMARY

Additional aspects and/or advantages will be set forth in part in the description which follows and, in part, will be apparent from the description, or may be learned by practice of the invention.

One or more exemplary embodiments may provide a method and an apparatus for providing content with streaming, capable of providing content information which matches a network environment of a user so that the user can select content of quality suitable for the network environment.

One or more exemplary embodiments may provide a method and an apparatus for providing content with streaming, capable of checking a network environment of a user in real time to provide content of quality suitable for the network environment.

According to an aspect of an exemplary embodiment, there is provided a method for providing content with streaming, including storing a plurality of pieces of content; receiving a content retrieval request from a user; checking a network environment of the user; retrieving content according to the content retrieval request; and providing content information in which the retrieved content matches the checked network environment.

The network environment may include a data transfer bandwidth of a content receiver of the user.

The method for providing content with streaming may further include downloading metadata on the retrieved content from a content provider which provides the retrieved content; parsing the downloaded metadata; obtaining a content access path which matches the data transfer bandwidth using the parsed metadata; and adding the content access path which matches the data transfer bandwidth to a retrieval result.

The method for providing content with streaming may further include downloading at least one segment on the content access path to provide a sample video.

The method for providing content with streaming may further include downloading a header of a content file on the content access path to provide image quality information.

The method for providing content with streaming may further include providing content suitable for the checked network environment of the user with streaming.

The network environment may further include a data transfer bandwidth of a content provider.

According to an aspect of another exemplary embodiment, there is provided a method for providing content with streaming, including classifying a plurality of pieces of content according to a network environment and storing the classified content; receiving a content retrieval request from a user; checking a network environment of the user; retrieving content suitable for the checked network environment of the user; and providing content information in which the retrieved content matches the checked network environment.

The network environment may include a data transfer bandwidth of a content receiver of the user.

The method for providing content with streaming may further include providing the content suitable for the checked network environment of the user with streaming according to a selection of the user.

According to an aspect of another exemplary embodiment, there is provided an apparatus for providing content with streaming, including a storage section to store a plurality of pieces of content; a communicating section which receives a content retrieval request from a user; a network environment checker which checks a network environment of the user; and a controller which retrieves content according to the content retrieval request and matches the retrieved content with the checked network environment.

The network environment may include a data transfer bandwidth of a content receiver of the user.

The apparatus for providing content with streaming may further include a metadata processing section which downloads metadata on the retrieved content from a content provider which provides the retrieved content and parses the downloaded metadata.

The controller may obtain a content access path which matches the data transfer bandwidth using the parsed metadata, and adds the content access path which matches the data transfer bandwidth to a retrieval result.

The controller may download at least one segment on the content access path to provide a sample video.

The controller may parse a header of a content file on the content access path to provide image quality information.

The controller may control the communicating section to provide content suitable for the checked network environment of the user with streaming.

The network environment may further include a data transfer bandwidth of a content provider.

According to an aspect of another exemplary embodiment, there is provided an apparatus for providing content with streaming, including a storage section which classifies a plurality of pieces of content according to a network environment and stores the classified content; a communicating section which receives a content retrieval request from a user; a network environment checker which checks a network environment of the user; and a controller which retrieves content suitable for the checked network environment of the user and provides content information in which the retrieved content matches the checked network environment.

The network environment may include a data transfer bandwidth of a content receiver of the user.

The controller may control the communicating section to provide content suitable for the checked network environment of the user with streaming according to a selection of the user.

According to the method and apparatus for providing content with streaming, it is possible to check a network environment of a user, that is, a bandwidth, to obtain optimal content information suitable for the network environment, and to allow the user to select optimal content.

Further, the user may be provided with content of quality suitable for the network environment from a content provider. That is, when the same content is provided by various content providers, the user may confirm and select the most optimal content.

Thus, it is possible to cause the content providers to provide services of superior image quality through image quality competition.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 shows a schematic configuration of an apparatus for providing content with streaming according to a first exemplary embodiment.

FIG. 2 shows a schematic configuration of an apparatus for providing content with streaming according to a second exemplary embodiment.

FIG. 3 is a block diagram showing a configuration of the apparatus for providing content with streaming according to the first exemplary embodiment.

FIG. 4 is a block diagram showing a configuration of the apparatus for providing content with streaming according to the second exemplary embodiment.

FIG. 5 shows a configuration of metadata used in exemplary embodiments.

FIG. 6 is a flowchart showing a configuration of the apparatus for providing content with streaming according to the first exemplary embodiment.

FIG. 7 is a flowchart showing a configuration of the apparatus for providing content with streaming according to the second exemplary embodiment.

FIG. 8 shows a schematic configuration of an apparatus for providing content with streaming in the related art.

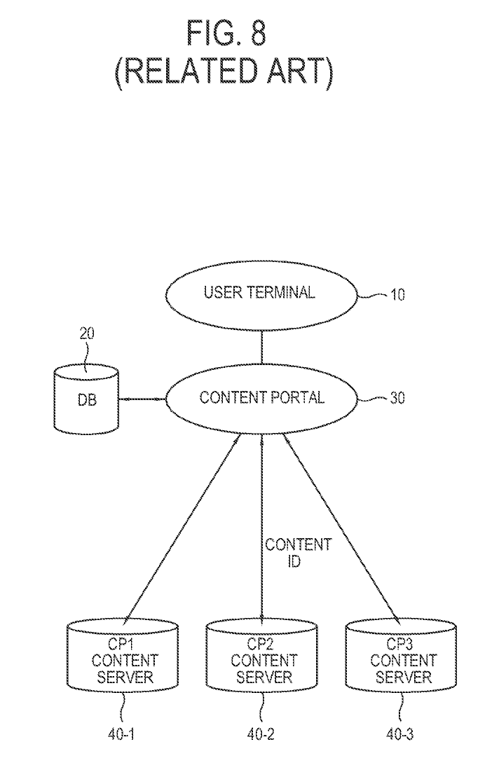

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, but this does not mean that the omitted parts are unnecessary for realization of apparatuses or systems to which the exemplary embodiments are applied. Like reference numerals refer to like elements throughout.

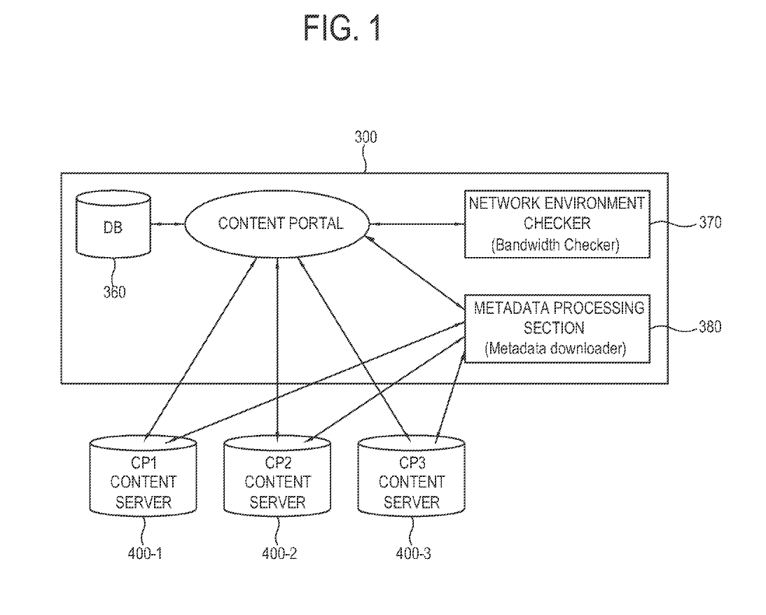

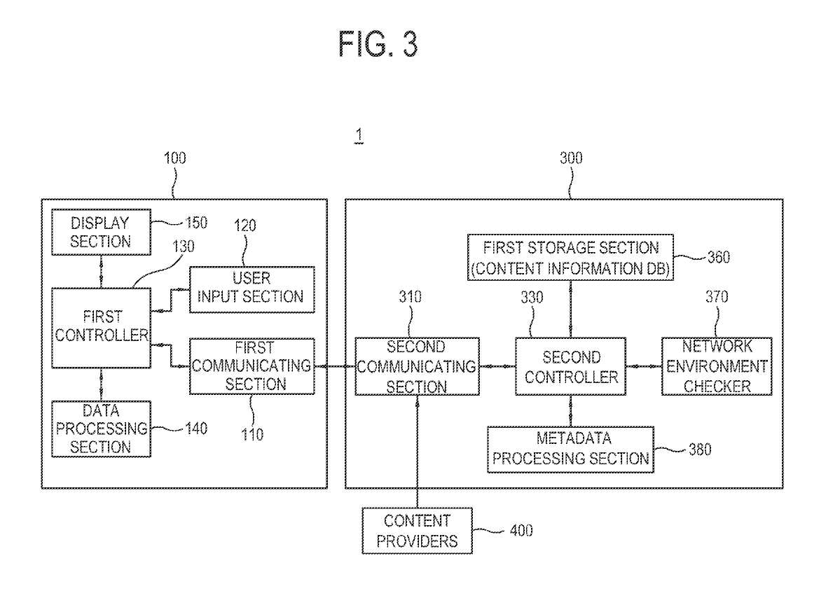

Referring to FIGS. 1 and 3, an apparatus 300 (hereinafter, referred to as a content portal 300) for providing content with streaming according to an exemplary embodiment stores content information provided by content providers 400 (400-1, 400-2 and 400-3) in a storage section (DB) 360. If the apparatus 300 receives a content retrieval request from a content receiver 100 of a user, the apparatus 300 performs retrieval on the basis of the content information stored in the storage section 360.

The content receiver 100 may employ any device as long as it is capable of requesting retrieval of content and receiving the content with streaming through wired or wireless communication, which may include a mobile terminal such as a smart phone, a tablet computer or a notebook computer, a desktop computer, a server, or the like.

The content receiver 100 may include a first communicating section 110, a user input section 120, a first controller 130, a data processing section 140, and a display section 150.

The first communicating section 110 may transmit, to a content portal 300, a keyword for content which is input by the user through a retrieval web page provided by the content portal 300, and may receive a retrieval result from the content portal 300.

The first communicating section 110 may employ data communication such as a very high-data rate digital subscriber line (VDSL), Ethernet, Token Ring, high definition multimedia interface (HDMI), universal serial bus (USB), component, low-voltage differential signaling (LVDS) or HDMI Ethernet channel (HEC); mobile communication such as 2G, 3G, 4G or long term evolution (LTE); wireless Internet such as a wireless local area network (WLAN: Wi-Fi), wireless broadband (WiBro), world interoperability for microwave access (Wimax) or high speed downlink packet access (HSDPA); near-distance wireless communication such as Bluetooth (registered trademark), radio-frequency identification (RFID), infrared data association (IrDA), ultra wideband (UWB) or Zigbee (registered trademark); or the like.

The user input section 120 may include a keyboard, a mouth, a keypad, a touch screen, a microphone, a remote controller, or the like.

The first controller 130 may control the respective components of the content receiver 100. For example, the first controller 130 may control the first communicating section 110, the user input section 120, the data processing section 140 and the display section 150. The first controller 120 may control the first communicating section 110 to receive a web page on which content information is displayed from the content portal 300, and may display the web page on the display section 150 through data processing. Further, if the user inputs a keyword through the web page, the first controller 130 may control the first communicating section 110 to transmit input data to the content portal 300.

The first controller 130 may include an application specific integrated circuit (ASIC), a digital signal processor (DSP), a programmable logic device (PLD), a field programmable gate array (FPGA), a micro-controller, a microprocessor, or the like.

The date processing section 140 processes various data input or received through the first communicating section 110 and the user input section 120 to be displayed on the display section 150.

The data processing section 140 may include an application such as a web browser which processes a web page received through the first communicating section 110.

Further, the data processing section 140 may perform the processes of de-multiplexing for distributing a predetermined data signal into signals having respective characteristics, decoding corresponding to a video format of a video signal, de-interlacing for converting an interlaced video signal into a progressive signal, scaling for adjusting a video signal to a preset resolution, noise reduction for improving image quality, detail enhancement, frame refresh rate conversion, and the like, for example.

The data processing section 140 may be provided as a video processing board in which a circuit configuration of various chipsets for executing the processes, a memory, electronic parts, wirings and the like is mounted on a printed circuit board.

The display section 150 may display data processed by the data processing section 140 to be visually viewed.

The display section 150 is not limited to a particular configuration, but may include various display panels using liquid crystal, plasma, light-emitting diodes, organic light-emitting diodes, a surface-conduction electron-gun, carbon nano-tubes, nano-crystal or the like.

The display section 150 may include an additional component according to its configuration. For example, in a case where the display section 150 employs a liquid crystal display panel, the display section 150 may include a backlight which supplies light and a panel drive board which drives the display panel.

Hereinafter, the apparatus 300 for providing content with streaming according to the first embodiment will be described.

The apparatus 300 for providing content with streaming may include the content portal 300 to store and provide content information provided by various content providers.

As shown in FIG. 3, the content portal 300 may include a second communicating section 310, a second controller 330, the first storage section 360, a network environment checker 370, and a metadata processing section 380.

The second communicating section 310 may communicate with the content receiver 100 of the user and the plurality of content providers 400. The second communicating section 310 may receive a content retrieval request from the first communicating section 110, and may provide retrieved content information to the first communicating section 110. Further, the second communicating section 310 may receive content information from the content providers 400.

The second controller 330 may control the respective components of the content portal 300. That is, the second controller 330 may control the second communicating section 310, the first storage section 360, the network environment checker 370 and the metadata processing section 380. The second controller 330 may control the second communicating section 310 to receive a content retrieval request transmitted from the content receiver 100 of the user and to transmit a web page including content information retrieved according to the request of the user. Here, the second controller 330 may transmit content information in which the retrieved content matches a network environment of the user to the content receiver 100 through the second communicating section 310.

The second controller 330 may match the network environment such as a bandwidth of the content receiver 100 and bandwidths of the content providers 400 with the retrieved content using the network environment of the user checked by the network environment checker 370 and downloaded metadata on the retrieved content, and may provide the result to the content receiver 100.

The second controller 330 may include an application specific integrated circuit (ASIC), a digital signal processor (DSP), a programmable logic device (PLD), a field programmable gate array (FPGA), a micro-controller, a microprocessor, or the like.

The first storage section 360 may include a database DB to store the content information provided by the content providers 400. The stored content information may be classified according to specific identifiers of the content providers 400.

The network environment checker 370 may check the network environment of the content receiver 100 of the user, for example, its bandwidth in real time for each content retrieval request of the user. Further, the network environment checker 370 may additionally check the bandwidths of the content providers 400. Here, the bandwidth may refer to the difference between the highest frequency and the lowest frequency of a signal which is usable in a network, or may refer to the maximum transfer rate, that is, information transfer ability which is usable in communication.

The metadata processing section 380 may download metadata on the content retrieved from the content providers 400, may parse the downloaded metadata, and may obtain an access path to content which matches a data transfer bandwidth using the parsed metadata.

The second controller 330 may provide the access path to the content which matches the data transfer bandwidth, obtained by the metadata processing section 380, in addition to the content to be provided to the content receiver 100 of the user.

Further, the second controller 330 may download at least one segment on the access path to provide a sample video, or may parse a header of a content file on the access path to provide image quality information.

Further, the second controller 330 may provide content suitable for the checked network environment, that is, the bandwidth of the content provider 100 or the bandwidths of the content providers 400 with streaming.

Here, the metadata refers to data on data, which is given to content according to a predetermined rule to efficiently search and use desired information from a large amount of data. The metadata may include information about the position, contents, creator, copyright validity, use conditions, usage history or the like of the content.

Another purpose of the metadata is to provide quick data search, which serves as an index of information in a computer.

A user may easily search desired data (information) using the metadata through a search engine or the like.

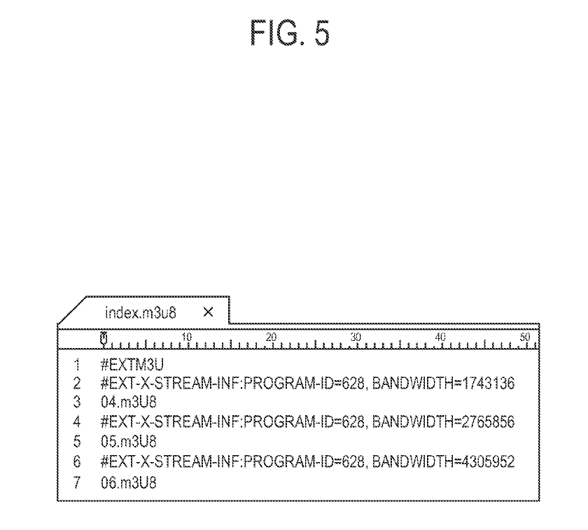

FIG. 5 shows an actual configuration example of a main metadata file based on the HTTP live streaming (HLS) standard. Here, EXTM3U in the first row represents a file of m3u8 format. In the second row, #EXT-X-STREAM-INF represents an indicator for content provision, PROGRAM ID=628 represents a unique value of content which is present in a play list file, and BANDWIDTH=1743236 represents a bps value expressed by decimal numeration. In the third, fifth and seventh rows, m3u8 represents a file format.

In this manner, content to be serviced is mapped in the metadata files according to bandwidths. That is, network bandwidths and appropriate bit rates (bps) match with each other for the same content.

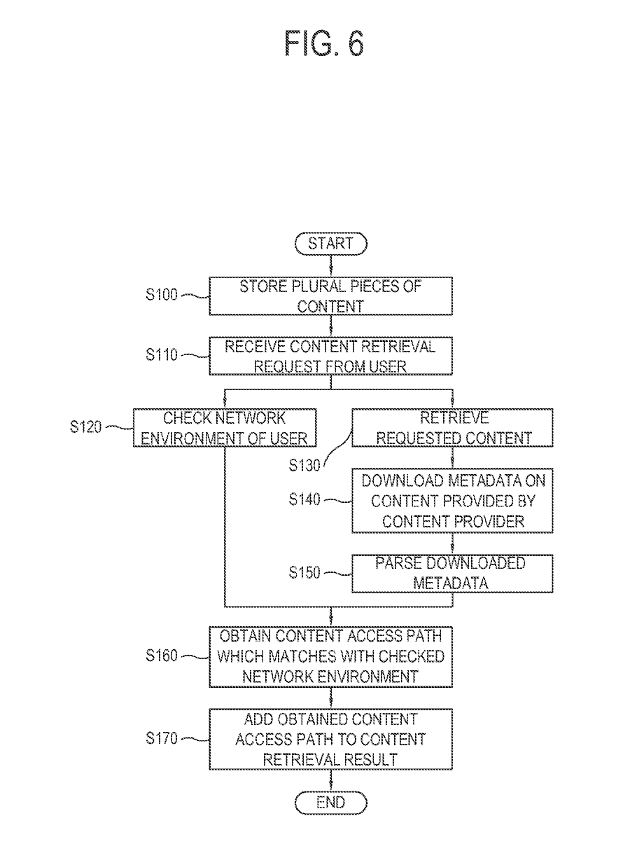

An operation of the apparatus 300 for providing content with streaming according to the above-described first exemplary embodiment will be described referring to FIGS. 3 and 6.

First, the content portal 300 stores content information provided by the content providers 400 in the first storage section 360 (S100).

A user requests retrieval of desired content information among the content information provided by the content portal 300 through the content receiver 100. For example, the user may input “AVATAR” for the retrieval request. Then, the content portal 300 receives the content retrieval request from the content provider 100 (S110).

If the retrieval request is received from the content receiver 100, the content portal 300 checks a network environment of the content receiver 100, for example, a bandwidth through the network environment checker 370 (S120).

The content portal 300 searches content IDs of the content providers 400 which provide “AVATAR” from a content ID list which is stored, managed and updated in the first storage 360, in addition to the bandwidth check (S130).

Then, the metadata processing section 380 downloads metadata through a reproduction uniform resource locator (URL) of content (video) pointed by each searched content ID (S140). Here, the metadata has a size of about 200 bytes, and may thus be downloaded in a very short time, which allows real-time downloading.

The metadata processing section 380 parses the downloaded metadata (S150), and obtains a content access path which matches the checked bandwidth of the content receiver 100 (S160).

Then, the metadata processing section 380 adds the obtained content access path which matches the bandwidth of the content receiver 100 to the content retrieval result, and provides the result to the content receiver 100 (S170).

In addition, the metadata processing section 380 may directly download a segment of content on the obtained access path to provide a sample video, or may parse a header of a corresponding transport stream (TS) file to provide image quality information.

Further, the network environment checker 370 may check network environments of the content providers 400 on the access path, for example, bandwidths. When the content receiver 100 receives desired content with streaming using the access path, the content receiver 100 may be provided with a streaming service in a better environment by referring to the bandwidths of the content providers 400.

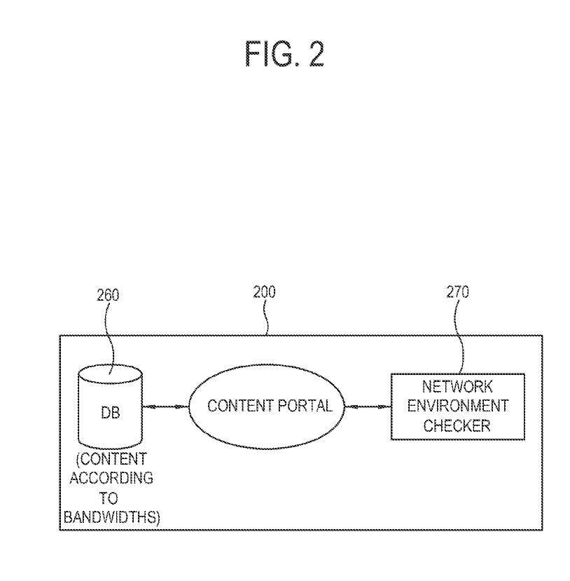

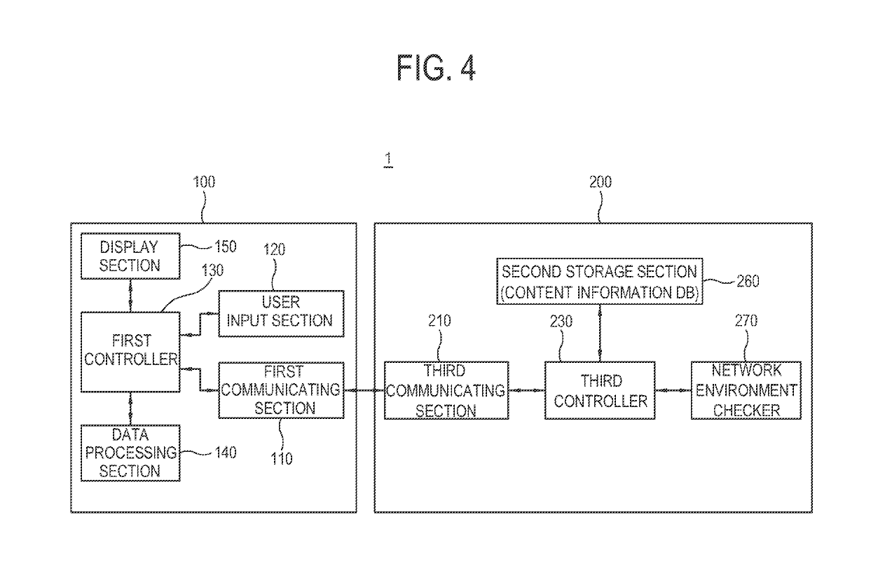

FIGS. 2 and 4 show an apparatus 200 for providing content with streaming (hereinafter, referred to as a content streaming service apparatus 200) according to a second exemplary embodiment.

The content streaming service apparatus 200 according to the second exemplary embodiment may directly classify and store content therein, differently from the apparatus 300 according to the first exemplary embodiment, and may provide retrieved content information according to a content retrieval request of a user.

The content receiver 100 of the user is the same as in the apparatus 300 according to the first exemplary embodiment, and description thereof will not be repeated.

As shown in FIG. 4, the content streaming service apparatus 200 may include a third communicating section 210, a third controller 230, a second storage section 260, and a network environment checker 270.

The third communicating section 210 may communicate with the first communicating section 110 of the content receiver 100 of the user. The third communicating section 210 may receive a content retrieval request from the first communicating section 110, and may provide content information and content as a retrieval result.

The third controller 230 may control the respective components of the content streaming service apparatus 200. For example, the third controller 230 may control the third communicating section 210, the second storage section 260 and the network environment checker 270. The third controller 230 may control the third communicating section 210 to receive a content retrieval request from the content receiver 100 and to transmit a web page on which content information is displayed according to the request of the user. Further, the third controller 230 may transmit content information in which retrieved content matches a network environment of the user to the content receiver 100 through the third communicating section 210.

The third controller 230 may retrieve content which matches the network environment of the user checked by the network environment checker 270 to provide the retrieved content to the content receiver 100.

The third controller 230 may include an application specific integrated circuit (ASIC), a digital signal processor (DSP), a programmable logic device (PLD), a field programmable gate array (FPGA), a micro-controller, a microprocessor, or the like.

The second storage section 260 may store content which is mapped in various bandwidths for the same content.

The network environment checker 270 may check the network environment of the content receiver 100 of the user, for example, a bandwidth for each content retrieval request of the user in real time.

The third controller 230 may provide content which matches the data transfer bandwidth obtained in this way to the content receiver 100 for selection of the user.

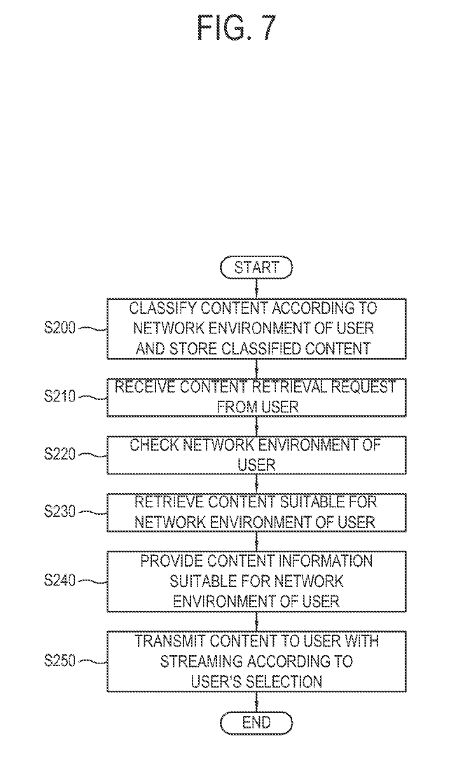

Hereinafter, a method for providing content with streaming according to the second exemplary embodiment will be described in detail referring to FIG. 7.

First, the content streaming service apparatus 200 maps various content according to various network environments, for example, various bandwidths, and stores the mapped content in the second storage section 260 in advance (S200).

If a user requests content retrieval to the content streaming service apparatus 200 through the content receiver 100 by inputting “AVATAR”, for example, the content streaming service apparatus 200 receives the content retrieval request from the content receiver 100 (S210).

After receiving the content retrieval request from the content receiver 100, the content streaming service apparatus 200 checks a network environment of the content receiver 100 of the user, for example, its bandwidth through the network environment checker 270 (S220).

Then, the content streaming service apparatus 200 retrieves the content “AVATAR” which matches the checked bandwidth from a content list which is stored, managed and updated in the second storage section 260 (S230).

The content streaming service apparatus 200 provides information about the retrieved content to the content receiver 100 for selection of the user (S240).

Finally, the content streaming service apparatus 200 transmits the content selected by the user to the content receiver 100 with streaming (S250).

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising non-transitory computer-readable recording media. The program/software implementing the embodiments may also be transmitted over non-transitory transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method for providing content with streaming, comprising:
storing a plurality of pieces of content;
receiving a content retrieval request from a user using a processor;
checking a network environment of the user;
retrieving content according to the content retrieval request; and
providing content information in which the retrieved content matches the checked network environment.

2. The method according to claim 1,
wherein the network environment comprises a data transfer bandwidth of a content receiver of the user.

3. The method according to claim 2, further comprising:
downloading metadata on the retrieved content from a content provider which provides the retrieved content;
parsing the downloaded metadata;
obtaining a content access path which matches the data transfer bandwidth using the parsed metadata; and
adding the content access path which matches the data transfer bandwidth to a retrieval result.

4. The method according to claim 3, further comprising:
downloading at least one segment on the content access path to provide a sample video.

5. The method according to claim 3, further comprising:
downloading a header of a content file on the content access path to provide image quality information.

6. The method according to claim 1, further comprising:
providing content suitable for the checked network environment of the user with streaming.

7. The method according to claim 2,
wherein the network environment further comprises a data transfer bandwidth of a content provider.

8. A method for providing content with streaming, comprising:
classifying a plurality of pieces of content according to a network environment and storing the classified content;
receiving a content retrieval request from a user using a processor;
checking a network environment of the user;
retrieving content suitable for the checked network environment of the user; and
providing content information in which the retrieved content matches the checked network environment.

9. The method according to claim 8,
wherein the network environment comprises a data transfer bandwidth of a content receiver of the user.

10. The method according to claim 9, further comprising:
providing the content suitable for the checked network environment of the user with streaming according to a selection of the user.

11. An apparatus for providing content with streaming, comprising:
a storage section to store a plurality of pieces of content;
a communicating section which receives a content retrieval request from a user;
a network environment checker which checks a network environment of the user; and
a controller which retrieves content according to the content retrieval request and matches the retrieved content with the checked network environment.

12. The apparatus according to claim 11,
wherein the network environment comprises a data transfer bandwidth of a content receiver of the user.

13. The apparatus according to claim 12, further comprising:
a metadata processing section which downloads metadata on the retrieved content from a content provider which provides the retrieved content and parses the downloaded metadata.

14. The apparatus according to claim 13,
wherein the controller obtains a content access path which matches the data transfer bandwidth using the parsed metadata, and adds the content access path which matches the data transfer bandwidth to a retrieval result.

15. The apparatus according to claim 14,
wherein the controller downloads at least one segment on the content access path to provide a sample video.

16. The apparatus according to claim 14,
wherein the controller parses a header of a content file on the content access path to provide image quality information.

17. The apparatus according to claim 11,
wherein the controller controls the communicating section to provide content suitable for the checked network environment of the user with streaming.

18. The apparatus according to claim 12,
wherein the network environment further comprises a data transfer bandwidth of a content provider.

19. An apparatus for providing content with streaming, comprising:
a storage section which classifies a plurality of pieces of content according to a network environment and stores the classified content;
a communicating section which receives a content retrieval request from a user;
a network environment checker which checks a network environment of the user; and
a controller which retrieves content suitable for the checked network environment of the user and provides content information in which the retrieved content matches the checked network environment.

20. The apparatus according to claim 19,
wherein the network environment comprises a data transfer bandwidth of a content receiver of the user.

21. The apparatus according to claim 20,
wherein the controller controls the communicating section to provide content suitable for the checked network environment of the user with streaming according to a selection of the user.

22. A non-transitory computer readable storage medium storing a program for providing content with streaming, the program causing a processor to:
classify a plurality of pieces of content according to a network environment and store the classified content;
receive a content retrieval request from a user;
check a network environment of the user;
retrieve content suitable for the checked network environment of the user; and
provide content information in which the retrieved content matches the checked network environment.
